(19) United States
(12) Patent Application Publication
(10) Pub. No.: US 2025/0299862 A1
(43) Pub. Date: Sep. 25, 2025

(54) MAGNETIC ACTUATOR DEVICE, MAGNETIC ACTUATOR FOR HYDROGEN GAS APPLICATIONS, AND PRODUCTION METHOD

(71) Applicant: ETO MAGNETIC GmbH, Stockach (DE)

(72) Inventors: Viktor RAFF, Konstanz (DE); Sven ROOS, Konstanz (DE); Jörg BÜRSSNER, Engen (DE)

(21) Appl. No.: 18/871,938

(22) PCT Filed: Jun. 7, 2023
(86) PCT No.: PCT/EP2023/065274

§ 371 Date: Dec. 5, 2024

(30) Foreign Application Priority Data
Jun. 9, 2022 (DE) 10 2022 114 586.7

(51) Int. Cl. H01F 7/16

(52) U.S. Cl. CPC H01F 7/16

(57) ABSTRACT

A magnetic actuator device, in particular hydrogen-gas-tight magnetic actuator device, includes at least one magnetic core and at least one core tube, which is at least substantially magnetically separated along its axial direction, wherein, for achieving a hydrogen gas tightness, the magnetic core is formed completely closed in the axial direction at least on one side and the core tube is realized monolithically with the magnetic core.

### CROSS-REFERENCE TO RELATED APPLICATIONS

This patent application is a U.S. national stage application of international patent application PCT/EP2023/065274, filed on Jun. 7, 2023, which is based on and claims priority to German patent application DE 10 2022 114 586.7, filed on Jun. 9, 2022, the contents of which are incorporated herein by reference.

### PRIOR ART

The invention concerns a magnetic actuator device, a magnetic actuator and methods.

In DE 102 35 644 B4 a magnetic actuator device with at least one monolithic magnetic core and with at least one core tube, which is at least substantially magnetically separated along its axial direction, has already been proposed.

The objective of the invention is in particular to provide a generic device with advantageous properties regarding a suitability for hydrogen gas applications. The objective is achieved according to the invention.

### ADVANTAGES OF THE INVENTION

The invention is based on a magnetic actuator device, in particular a hydrogen-gas-tight magnetic actuator device, with at least one, in particular monolithic, magnetic core and with at least one core tube, which is at least substantially magnetically separated along its axial direction.

It is proposed that for achieving a hydrogen gas tightness, in particular a leakage rate of less than 10⁻⁴ mbar l/s, preferably of less than 10⁻⁵ mbar l/s and preferentially of less than 10⁻⁶ mbar l/s, the magnetic core is formed completely closed in the axial direction at least on one side and the core tube is realized monolithically with the magnetic core. This advantageously allows achieving favorable suitability for hydrogen gas applications, for example in the field of fuel cells and/or electrolyzers. Advantageously, a high degree of tightness is achievable, as a result of which in particular an escape of hydrogen from an interior of the core tube can be prevented. It is advantageously possible to avoid leakages, in particular also for the smallest known gas molecules—H₂ molecules. It is advantageously possible to completely dispense with sealing points, such as soldering points or welding points. Advantageously a risk of leakage due to shrink holes or the like can be kept at a low level. In particular, it is advantageously possible to achieve a high degree of tightness, even for H₂ molecules, without substantially impairing the functionality or the functional parameters of the magnetic actuator device. In particular, the hydrogen-gas-tight magnetic actuator device has a leakage rate of less than 10⁻⁴ mbar l/s, preferably of less than 10⁻⁵ mbar l/s and preferentially of less than 10⁻⁶ mbar l/s. A “magnetic actuator device” is in particular to mean an, in particular operational, component, in particular a structural and/or functional component, of a magnetic actuator. A “magnetic actuator” is in particular to mean an actuator, which is preferably based on the reluctance principle and which performs mechanical work by translational movements, such as for example a solenoid valve or a magnetic switch. The magnetic actuator is in particular to mean, in this context, a device which is configured to convert an electrical power into a mechanical power by means of a magnetic field.

A “core tube” is in particular to mean a component of a magnetic actuator which is made of a magnetic-flux-conducting (magnetic-flux-bundling), in particular magnetic (soft-magnetic) material, preferably ferromagnetic material, and which preferably, at least to a large portion, forms the magnetic core of the magnetic actuator and/or is arranged at least partly, preferably at least to a large portion, in a coil interior of a magnetic coil of the magnetic actuator. In particular, the magnetic material is realized as a magnetic work substance. In particular, the core tube is at least to a large portion made of a magnetic steel. In particular, the core tube together with at least one magnetic coil of the magnetic actuator creates an inductance. In particular, the core tube is realized at least partly and/or at least on one side in a tubular shape. In particular, the core tube is configured to at least partly accommodate a magnet armature of the magnetic actuator. In particular, the core tube is configured to at least partly form a displacement space for the magnet armature of the magnetic actuator. In particular, the displacement space for the magnet armature is formed by the tubular part of the core tube. In particular, the longitudinal direction of the core tube runs parallel to a tube axis, in particular a rotational symmetry axis, of the tubular part of the core tube. In particular, the longitudinal direction of the core tube, when mounted in a magnetic actuator, runs parallel to a coil axis of the magnetic coil of the magnetic actuator. “Configured” is in particular to mean specially programmed, designed and/or equipped. By an object being configured for a specific function is in particular to be understood that the object fulfils and/or carries out this specific function in at least one application state and/or operation state.

A “magnetic separation” of the core tube is in particular to mean that two subregions (made of the same magnetic material) of the core tube are separate from one another in such a manner that at least a large portion of all magnetic field lines running in a first subregion of the core tube are prevented from passing directly into the second subregion of the core tube. A “magnetic separation” of the core tube is in particular to mean an interruption of the magnetic flux conductivity of the core tube. In particular, the magnetic separation is configured to interrupt the magnetic flux through the core tube along the axial direction of the core tube. In particular, the magnetic separation is configured to divert the magnetic field lines of the magnetic field of the magnetic coil in such a way that in the region of the magnetic separation the magnetic field lines are directed out of the core tube. In particular, the magnetic separation is arranged in a region of the core tube which, in a mounted state of the magnetic actuator, is arranged in the coil interior of the magnetic coil. In particular, the magnetic separation is arranged in a region of the core tube which, in the mounted state of the magnetic actuator, forms the displacement space for the magnet armature. In particular, the axial direction of the core tube runs parallel to a longitudinal direction of the core tube. In particular, the axial direction of the core tube runs parallel to a main extension direction of the core tube. By a “main extension direction” of an object is in particular a direction to be understood which runs parallel to a longest edge of a smallest geometric cuboid just still completely enclosing the object. “Completely closed” is in particular to mean free of perforations or breakthroughs in the axial direction. In particular, the magnetic core is on the closed side free of further elements or components penetrating the magnetic core, such as e.g. valve tappets or the like. In particular, the entire core tube is realized monolithically with the magnetic core. In particular, the core tube is free of separate separating elements, for example separating elements connected to the core tube by material bond, which would separate the core tube into two or more parts that are not connected to one another. The term “monolithically” is in particular also to mean in a one-part implementation (formed in one piece or formed from a single blank, a mass and/or a cast).

Moreover, it is proposed that the magnetic separation of the monolithic core tube is realized at least partly by a demagnetization of a material of the core tube wall of the core tube in a separation region of the core tube, in particular generated by thermal microstructural transformation of the material of the core tube wall, e.g. by induction or by laser annealing. In this way efficient magnetic separation is advantageously achievable while maintaining a high degree of gas tightness and maintaining a high stability of the core tube. In particular, the core tube may in this case have an unchanged wall thickness in the separation region, in particular a wall thickness at least substantially identical to a wall thickness outside the separation region.

It is also proposed that in the separation region of the core tube the material of the monolithic core tube wall of the core tube has a magnetically poorly conductive microstructure, in particular a metal microstructure, e.g. a martensitic microstructure, and that outside the separation region of the core tube the material of the monolithic core tube wall of the core tube has a magnetically highly conductive microstructure, in particular a metal microstructure, e.g. a ferritic microstructure. In this way efficient magnetic separation is advantageously achievable while maintaining a high degree of gas tightness, and in particular also maintaining a high stability of the core tube. In particular, the core tube is originally produced completely from a material having a magnetically highly conductive microstructure, in particular a metal microstructure, e.g. a ferritic microstructure, and is treated subsequent to the production in such a way that in the separation region the material undergoes a microstructural transformation to the magnetically poorly conductive microstructure, in particular a metal microstructure, e.g. a martensitic microstructure. In particular, the material having the magnetically poorly conductive microstructure extends in the separation region over an entire wall thickness of the core tube.

Furthermore, it is proposed that the magnetic separation of the core tube is realized at least partly by a tapering of a wall thickness of a core tube wall of the core tube in a separation region of the core tube. In this way efficient magnetic separation is advantageously achievable while maintaining a high degree of gas tightness. It is advantageously possible to avoid leakage due to shrink holes or the like, which may arise during welding or soldering, or due to surface roughnesses of elastomer seals or the like. In particular, the magnetic separation is free of elastomers, welding points or soldering points. In particular, the wall thickness of the core tube wall is in the separation region tapered in such a way that in normal operation of the magnetic actuator the magnetic field lines are almost automatically directed-completely or at least almost completely-out of the material of the core tube. A “tapering” of the wall thickness is in particular to mean a substantial reduction of the wall thickness. A “tapering” is in particular to mean a narrowing/thinning of the core tube wall. In addition to the tapering, the material in the separation region may also undergo the microstructural transformation to the magnetically poorly conductive, e.g. martensitic, microstructure or may be free of a microstructural transformation (i.e. continue to have the magnetically highly conductive microstructure, e.g. the ferrite).

If the core tube wall is in the separation region tapered at least to a third, preferably at least to a quarter, preferably at least to a fifth, of an average wall thickness of the core tube wall outside the separation region, good magnetic separation with at the same time a high degree of gas tightness, in particular hydrogen gas tightness, is advantageously achievable. In particular, the wall thickness of the core tube wall outside the separation region, and in particular at a distance from the monolithic magnetic core, is at least substantially constant.

If herein the, in particular tapered, wall thickness of the core tube wall is in the separation region less than 0.5 mm, preferably less than 0.4 mm, advantageously less than 0.3 mm, preferentially less than 0.2 mm and particularly preferably more than 0.1 mm, good magnetic separation with at the same time a high degree of gas tightness, in particular hydrogen gas tightness, is advantageously achievable. In addition, it is advantageously possible to ensure sufficient stability of the core tube, e.g. against bending.

It is further proposed that in the, in particular tapered, separation region an outer diameter of the core tube is reduced, in particular relative to an average outer diameter of the core tube outside the separation region, and/or that in the, in particular tapered, separation region an inner diameter of the core tube is increased, in particular relative to an average inner diameter of the core tube outside the separation region. In this way a simple construction is advantageously achievable. For example, the tapering in the separation region may be created by turning-in of a groove on the outer circumference of the core tube and/or on an inner circumference of the core tube. In particular, the tapering is in the separation region realized uniformly (as a uniform groove, i.e. e.g. as a groove of constant depth and constant width) and/or in rotationally symmetrical fashion. In particular, the core tube has on an outer wall a circumferential groove which forms the separation region. Alternatively or additionally, the core tube has on an inner wall a circumferential groove which forms the separation region. Herein a normal vector of the outer wall of the core tube in particular points in the radial direction of the core tube. Herein a normal vector of the inner wall of the core tube in particular points counter to the radial direction of the core tube.

Furthermore, it is proposed that the tapered wall thickness is in the separation region at least substantially constant at least over a large portion of an entire axial extent of the tapering. This allows achieving an advantageous magnetic field profile. Advantageously, a precise and/or location-specifically accurate magnetic separation is achievable. In addition, a simple construction is advantageously achievable. A large portion is in particular to mean 51%, preferably 66%, preferentially 75% and particularly preferentially 90%. In particular, a wall surface of the core tube is realized at least in a large portion of the separation region in planar fashion and/or so as to extend parallel to the axial direction of the core tube. The axial extent is realized as an extent of an object along the axial direction of an object.

Beyond this it is proposed that a space created as a result of the tapering in the separation region, in particular a groove created by the tapering in the separation region, is realized free of a material filling, in particular free of soldering agents or the like. In this way a simple construction is advantageously achievable.

Furthermore, if the tapering has a magnetic field conducting contour at least on the magnetic core side, and/or if the tapering has a further magnetic field conducting contour at least on the core tube side, it is possible to obtain an especially advantageous magnetic field profile, in particular an especially favorable magnetic separation of the core tube. In particular, the magnetic field conducting contour forms a cone geometry of the core tube for influencing and/or for designing a force-displacement characteristic of the magnetic actuator comprising the core tube. Advantageously a force-displacement characteristic of the magnetic actuator comprising the core tube can be defined by the selection of the shape of the magnetic field conducting contour. In particular, the magnetic field conducting contour is arranged on a lateral boundary of the tapering/groove, which at least substantially delimits the tapering/groove in a direction that runs parallel to the longitudinal direction. The magnetic field conducting contour may be realized as a sequence of edges, angles and/or radii. In particular, the magnetic field conducting contour has at least two different radii. In particular, the magnetic field conducting contour has at least two edges. However, it is also conceivable that the magnetic field conducting contour has only one edge and two surfaces or only one radius and two surfaces or the like. In particular, the magnetic field conducting contour is realized in a manner enabling a particularly good and/or particularly loss-free transition of the magnetic field from the magnetic core into the magnet armature. In particular, the shape of the magnetic field conducting contour is determined in a calculation and/or simulation step. In particular, the magnetic field conducting contour may have different shapes depending on the respectively desired force-displacement characteristic of the magnetic actuator. In particular, the magnetic field conducting contour is realized in rotationally symmetrical fashion. In particular, the magnetic field conducting contour is turned-in into the core tube. In particular, one of the lateral boundaries. with the lateral boundary of the tapering/groove situated opposite the magnetic field conducting contour, may be free of a further magnetic field conducting contour, or may likewise have a magnetic field conducting contour of the same shape or of a different shape.

It is moreover proposed that, viewed in the axial direction, the magnetic field conducting contour runs completely within a radial region which proceeds from the axial direction and in which there is also a maximum reluctance gap that can be produced between the magnetic core and the magnet armature of the magnetic actuator device in normal operation, and/or that, viewed in the axial direction, the further magnetic field conducting contour runs completely outside a radial region which proceeds from the axial direction and in which there is also a maximum reluctance gap that can be produced between the magnetic core and the magnet armature of the magnetic actuator device in normal operation. This allows achieving an especially advantageous profile of the magnetic field, in particular a particularly good magnetic separation of the core tube.

It is further proposed that the separation region, which completely comprises the tapering, has a total extent in the axial direction which is at most 25%, preferably at most 15%, of a total extent of the magnetic core in the axial direction, which is at most 25%, preferably at most 15%, of a total extent of a magnet armature of the magnetic actuator device in the axial direction, and/or which is at most 25%, preferably at most 15%, of a total extent of a magnetic coil of the magnetic actuator device in the axial direction. In this way a simple construction is advantageously achievable. It is advantageously possible to achieve favorable stability. In addition, it is advantageously possible to achieve a precise and/or location-specifically accurate magnetic separation. In particular, the total extent of the tapering in the separation region is measured parallel to the axial direction of the core tube.

It is also proposed that the magnetic actuator device comprises a magnetic anti-adhesive element which, in the axial direction, is arranged completely outside the separation region, in particular completely outside a radial region that proceeds from the axial direction and the extent of which in the axial direction is delimited by an extent of the tapering in the axial direction. This allows achieving an advantageous magnetic field conduction and/or magnet armature movement. In particular, the anti-adhesive element is made of a non-magnetic material. In particular, the anti-adhesive element is realized in a disk shape. In particular, the anti-adhesive element is arranged and/or fastened, in particular glued, to a side of the magnetic core that faces towards the core tube. In particular, the anti-adhesive element is configured to prevent a (magnetic) adhesion of the magnet armature at the magnetic core, in particular due to a residual magnetization of the magnetic core. Advantageously, this also allows achieving high dynamics of the magnetic actuator device. The anti-adhesive element is in particular configured to ensure a minimum distance between the magnetic core and the magnet armature. The magnet armature is in particular at least to a large portion made of a magnetic material, e.g. iron.

Beyond this, it is proposed that the core tube is on its inner side and/or on its outer side provided at least section-wise with a hydrogen diffusion inhibiting coating. This advantageously allows achieving favorable suitability for hydrogen gas applications, for example in the field of fuel cells and/or electrolyzers. Advantageously a high degree of tightness is achievable, as a result of which in particular an escape of hydrogen from an interior of the core tube can be prevented. It is advantageously possible to avoid leakages, in particular also for the smallest known gas molecules—H₂ molecules. In particular, the coating is configured to effectively protect iron or steel from an ingress of hydrogen (H₂). For example, the coating could be realized from a MAX-phase material which is in particular suitable and/or configured for hydrogen diffusion inhibition. For example, the coating is realized as a MAX-phase layer made of (oxidized) titanium, aluminum and nitrogen (Ti₂AlN). In particular, the hydrogen diffusion inhibiting coating is configured to reduce a hydrogen diffusion through the core tube, in particular in the separation region, at least by a factor of 2, preferably at least by a factor of 4, preferentially at least by a factor of 10 and particularly preferentially at least by a factor of 25, in particular in comparison with a coating-free and otherwise identical separation region. In particular, a large portion of an inner side and/or of an outer side of the core tube, or the entire inner side and/or outer side of the core tube may be provided with the hydrogen diffusion inhibiting coating. Preferably, however, at least a large portion of the separation region, preferentially at least the entire separation region, particularly preferentially at least the entire tapering, is on the inner side and/or on the outer side provided with the hydrogen diffusion inhibiting coating.

In addition, a magnetic actuator for hydrogen gas applications, in particular for fuel cell and/or electrolyzer applications, with the magnetic actuator device, is proposed. Advantageously, a high degree of tightness is achievable.

Furthermore, a method for producing the magnetic actuator device is proposed, wherein the magnetic core and the core tube are manufactured as monolithic components, and are in particular cut out of a monolithic block, and wherein the magnetic separation of the core tube is brought about by a tapering of a wall thickness of a core tube wall of the core tube, forming an unfilled separation region. In this way a simple construction with a particularly high degree of tightness for hydrogen gas is advantageously achievable.

Moreover, a method for producing the magnetic actuator device is proposed, wherein the magnetic core and the core tube are manufactured as monolithic components, and are in particular cut out of a monolithic block, and wherein the magnetic separation of the monolithic core tube is brought about by a demagnetization of a material of the core tube wall of the core tube in a separation region of the core tube. This advantageously allows achieving a simple construction with a particularly high degree of tightness for hydrogen gas and with a particularly high core tube stability.

It is further proposed that the demagnetization of the material of the core tube wall is generated by induction heating of the separation region or by laser annealing of the separation region. This advantageously allows providing a simple and/or cost-effective and/or quick production method.

The magnetic actuator device according to the invention, the magnetic actuator according to the invention and/or the methods according to the invention shall here not be limited to the above-described application and implementation. In particular, in order to fulfil a functionality that is described here, the magnetic actuator device according to the invention, the magnetic actuator according to the invention and/or the methods according to the invention may have a number of individual elements, components and units that differs from a number given here.

### DRAWINGS

Further advantages will become apparent from the following description of the drawings. An exemplary embodiment of the invention is shown in the drawings. The drawings, the description, and the claims contain a plurality of features in combination. Someone skilled in the art will purposefully also consider the features individually and will find further expedient combinations.

In the drawings:

FIG. 1 shows a schematic sectional view of a magnetic actuator with a magnetic actuator device;

FIG. 2 shows an enlargement of the illustration of FIG. 1 in a separation region of the magnetic actuator device;

FIG. 3 shows a schematic flow chart of a method for producing the magnetic actuator device; and

FIG. 4 shows a separation region of an alternative magnetic actuator device in a sectional view.

### DESCRIPTION OF THE EXEMPLARY EMBODIMENT

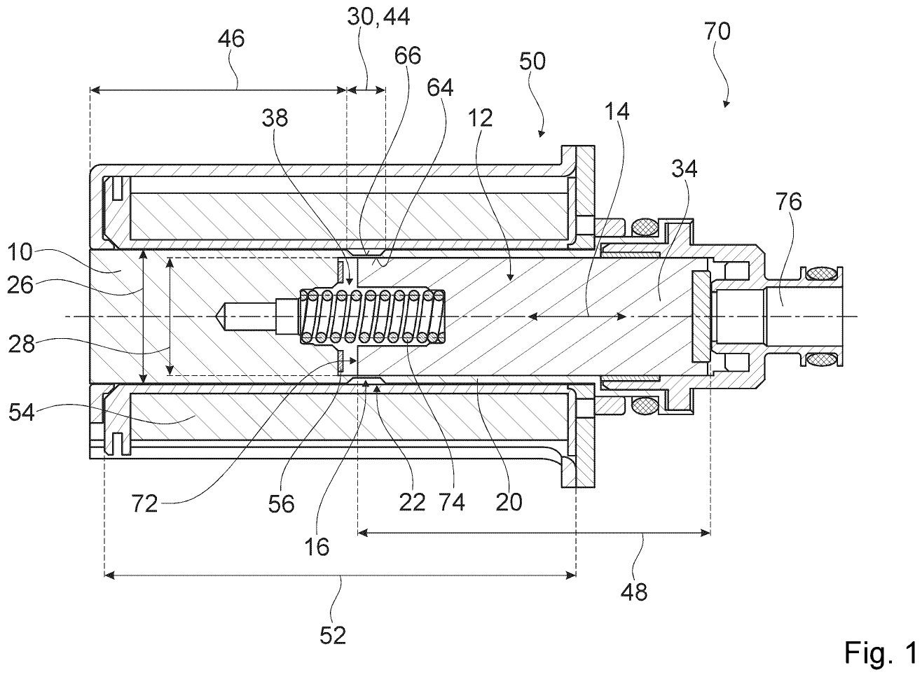

FIG. 1 shows a schematic sectional view of a magnetic actuator 70. The magnetic actuator 70 is configured for hydrogen gas applications. The magnetic actuator 70 is configured for fuel cell applications and/or for electrolyzer applications. The magnetic actuator 70 comprises a magnetic actuator device 50. The magnetic actuator device 50 is realized as a hydrogen-gas-tight magnetic actuator device. The magnetic actuator device 50 comprises a magnetic core 10. The magnetic actuator device 50 comprises a core tube 12. The core tube 12 and the magnetic core 10 are realized monolithically. The core tube 12 has an axial direction 14. The axial direction 14 runs parallel to an inner opening 72 of the core tube 12. The magnetic core 10 is completely closed on one side in the axial direction 14 of the core tube 12. The core tube 12 is completely closed on one side in the axial direction 14 by the magnetic core 10. This allows achieving a hydrogen gas tightness of the core tube 12, in particular of the inner opening 72 of the core tube 12 toward the outside.

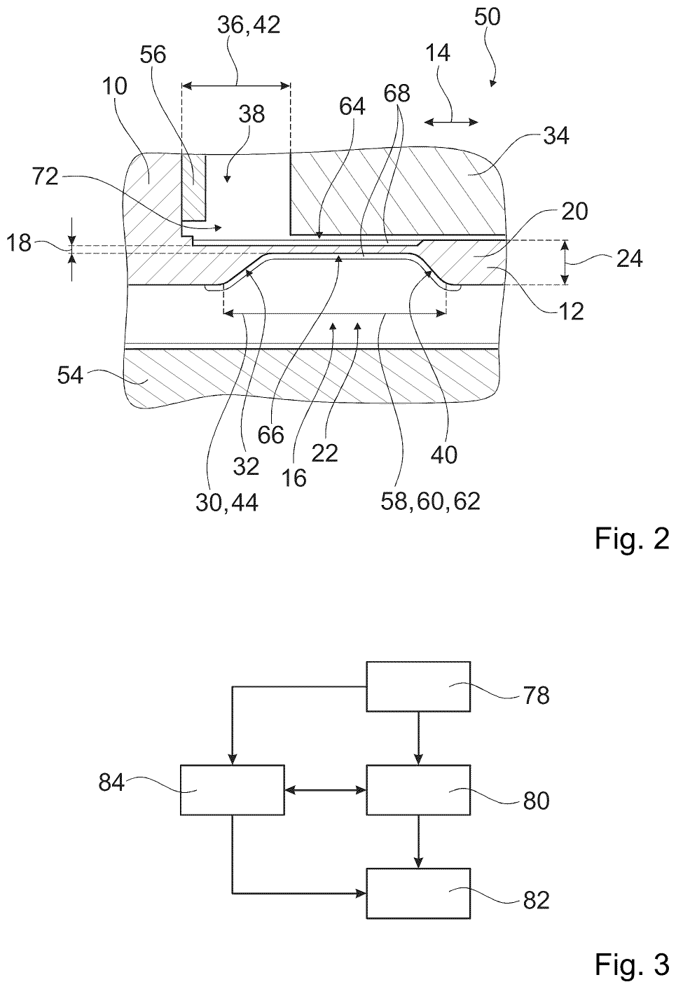

The core tube 12 is realized so as to be at least substantially magnetically separated along its axial direction 14. The core tube 12 forms a separation region 22. The core tube 12 is magnetically separated in the separation region 22. The core tube 12 comprises a core tube wall 20. Outside the separation region 22, the core tube wall 20 has an average wall thickness 24 (cf. FIG. 2). Outside the separation region 22, the average wall thickness 24 of the core tube wall 20 is more than 0.5 mm. Inside the separation region 22, the core tube wall 20 has a tapered wall thickness 18 (cf. FIG. 2). The wall thickness 18 of the core tube wall 20 in the separation region 22 is less than 0.5 mm. The magnetic separation of the core tube 12 in the separation region 22 is brought about by a tapering 16 of the wall thickness 18 of the core tube wall 20 of the core tube 12 in the separation region 22 of the core tube 12 relative to the average wall thickness 24 outside the separation region 22. In the separation region 22, the core tube wall 20 is tapered at least to a third of the average wall thickness 24 of the core tube wall 20 outside the separation region 22. The tapered wall thickness 18 in the separation region 22 is at least substantially constant over an axial extent 30 of the tapering 16 (cf. FIG. 2).

The core tube 12 has an outer diameter 26. The outer diameter 26 of the core tube 12 is reduced in the separation region 22. The core tube 12 has an inner diameter 28. In the figures, the inner diameter 28 of the core tube 12 is constant. However, it is conceivable that in addition or alternatively to the reduction of the outer diameter 26 of the core tube 12, the inner diameter 28 of the core tube 12 is increased (not shown). As a result of the tapering 16, a (free) space is created in the separation region 22. The space created by the tapering 16 is realized free of a material filling. The separation region 22, which completely comprises the tapering 16, has a total extent 44 in the axial direction 14, which is smaller than 15% of a total extent 46 of the magnetic core 10 in the axial direction 14.

The magnetic actuator 70 comprises a magnetic coil 54. The magnetic coil 54 can be supplied with current for generating a magnetic field. The magnetic actuator device 50 comprises a magnet armature 34. The magnet armature 34 is partly inserted in the core tube 12. The magnet armature 34 is supported movably in the core tube 12. The magnet armature 34 is movable in the core tube 12 by the magnetic field of the magnetic coil 54. The magnetic actuator device 50 comprises a reset spring 74. The reset spring 74 is clamped between the magnetic core 10 and the magnet armature 34. The reset spring 74 presses the magnet armature 34 away from the magnetic core 10 in a state when the magnetic coil 54 is not supplied with current. The magnetic actuator device 50 forms a reluctance gap 38. In a state when current is supplied, the magnet armature 34 seeks to close the reluctance gap 38 and is as a result pressed towards the magnetic core 10. The magnetic actuator 70 comprises an actuating element 76. The actuating element 76 serves for transmitting the movement of the magnet armature 34 outwards. The total extent 44 in the axial direction 14 of the separation region 22, which completely comprises the tapering 16, is smaller than 15% of a total extent 48 of the magnet armature 34 in the axial direction 14. The total extent 44 in the axial direction 14 of the separation region 22, which completely comprises the tapering 16, is smaller than 15% of a total extent 52 of the magnetic coil 54 in the axial direction 14. The magnetic actuator device 50 comprises a magnetic anti-adhesive element 56.

FIG. 2 schematically shows an enlargement of a detail of the magnetic actuator device 50 in the separation region 22 with the tapering 16. The tapering 16 has a magnetic field conducting contour 32 on the magnetic core side. Viewed in the axial direction 14, the magnetic field conducting contour 32 runs completely within a radial region 36 which proceeds from the axial direction 14 and in which there is also the maximum reluctance gap 38 that is producible between the magnetic core 10 and the magnet armature 34 in normal operation. The tapering 16 has a further magnetic field conducting contour 40 on the core tube side. The magnetic field conducting contour 32 and the further magnetic field conducting contour 40 are realized differently from one another. Viewed in the axial direction 14, the further magnetic field conducting contour 32 runs completely outside a radial region 42 which proceeds from the axial direction 14 and in which there is also the maximum reluctance gap 38 that can be produced in normal operation. The reluctance gap 38 shown by way of example in FIGS. 1 and 2 represents the maximum possible reluctance gap 38 of the implementation shown. The anti-adhesive element 56 is arranged completely outside the separation region 22 in the axial direction 14. The anti-adhesive element 56 is arranged completely outside a radial region 58 which proceeds from the axial direction 14 and the extent 62 of which in the axial direction 14 is delimited by an extent 60 of the tapering 16 in the axial direction 14.

The magnetic actuator device 50 comprises a hydrogen diffusion inhibiting coating 68. The hydrogen diffusion inhibiting coating 68 is applied on a portion of an inner side 64 of the core tube 12. The hydrogen diffusion inhibiting coating 68 is applied on a portion of an outer side 66 of the core tube 12. The core tube 12 is on the inner side 64 and on the outer side 66 at least section-wise provided with the hydrogen diffusion inhibiting coating 68. Alternatively, the hydrogen diffusion inhibiting coating 68 may be applied only to one of the two sides 64, 66 of the core tube 12. The hydrogen diffusion inhibiting coating 68 may be realized as a MAX-phase layer made of (oxidized) titanium, aluminum and nitrogen (Ti₂AlN). However, alternative or additional hydrogen diffusion inhibiting coatings 68 are of course also conceivable.

FIG. 3 shows a schematic flow chart of a method for producing the magnetic actuator device 50. In at least one method step 78, the magnetic core 10 and the core tube 12 are manufactured as a monolithic component. In the method step 78, the magnetic core 10 and the core tube 12 are cut out of a single monolithic block. Herein the magnetic core 10 and the core tube 12 are manufactured in such a way that the magnetic core 10 completely closes the core tube 12 on one side. In at least one further method step 80, the magnetic separation of the core tube 12 is realized by the tapering 16 of the wall thickness 18, 24 of the core tube wall 20 of the core tube 12. The tapering 16 herein forms a separation region 22, which remains unfilled. In the method step 80, the tapering 16 is created by turning-in a groove on the outer side 66 of the core tube 12 and/or by turning-in a groove on the inner side 64 of the core tube 12. In at least one method step 84, alternatively or additionally to the method step 80, the magnetic separation of the monolithic core tube 12 is realized by a demagnetization of a material of the core tube wall 20 of the core tube 12 in a separation region 22 of the core tube 12. In the method step 84, the demagnetization of the material of the core tube wall 20 is brought about by induction heating of the separation region 22 or by laser annealing of the separation region 22. In at least one method step 82, the hydrogen diffusion inhibiting coating 68 is applied onto the outer side 66 of the core tube 12 and/or onto the inner side 64 of the core tube 12. Herein, in the method step 82, the hydrogen diffusion inhibiting coating 68 is applied at least onto the surfaces of the core tube 12 which are located in the separation region 22. In normal operation of the magnetic actuator 70, the inner opening 72 of the core tube 12 is filled with hydrogen gas.

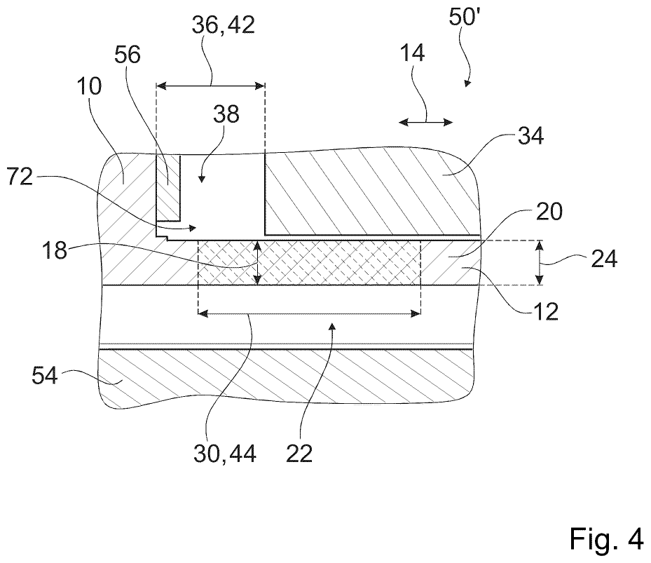

In FIG. 4 a further exemplary embodiment of the invention is shown. The following descriptions and the drawings are essentially limited to the differences between the exemplary embodiments, wherein in principle, with regard to components having the same designation, in particular with regard to components having the same reference numerals, reference may also be made to the drawings and/or the description of the other exemplary embodiment, in particular of FIGS. 1 to 3.

FIG. 4 schematically shows an enlargement of a detail of an alternative magnetic actuator device 50′ in a separation region 22 of a core tube 12. Outside the separation region 22, the alternative magnetic actuator device 50′ has substantially the same construction as the magnetic actuator device 50 shown in the preceding figures. The separation region 22 is realized free of a tapering. The core tube 12 is magnetically separated in the separation region 22. The core tube 12 comprises a core tube wall 20. Outside the separation region 22, the core tube wall 20 has an average wall thickness 24. Inside the separation region 22, the core tube wall 20 has an average wall thickness 18. The wall thicknesses 18, 24 inside and outside the separation region 22 are at least substantially identical. The magnetic separation of the monolithic core tube 12 is brought about by a demagnetization of a material of the core tube wall 20 of the core tube 12 in the separation region 22 of the core tube 12. The material of the monolithic core tube wall 20 of the core tube 12 in the separation region 22 of the core tube 12 has a magnetically poorly conductive microstructure, in particular metal microstructure. The material of the monolithic core tube wall 20 of the core tube 12 in the separation region 22 of the core tube 12 has a martensitic microstructure. Outside the separation region 22 of the core tube 12, the material of the monolithic core tube wall 20 of the core tube 12 has a magnetically highly conductive microstructure, in particular metal microstructure. Outside the separation region 22 of the core tube 12, the material of the monolithic core tube wall 20 of the core tube 12 has a ferritic microstructure.

In addition to the tapering 16, the magnetic actuator device 50 of FIGS. 1 to 3 may also have the microstructural transformation in the separation region 22, which has been described in connection with the alternative magnetic actuator device 50′.

1. Magnetic actuator device, in particular hydrogen-gas-tight magnetic actuator device, with at least one magnetic core and with at least one core tube, which is at least substantially magnetically separated along its axial direction, wherein for achieving a hydrogen gas tightness, the magnetic core is formed completely closed in the axial direction at least on one side and the core tube is realized monolithically with the magnetic core.

2. Magnetic actuator device according to claim 1, wherein the magnetic separation of the monolithic core tube is realized at least partly by a demagnetization of a material of the core tube wall of the core tube in a separation region of the core tube, in particular brought about by thermal microstructural transformation of the material of the core tube wall, e. g. by induction or by laser annealing.

3. Magnetic actuator device according to claim 1, wherein in the separation region of the core tube the material of the monolithic core tube wall of the core tube has a magnetically poorly conductive microstructure, in particular metal microstructure, e.g. a martensitic microstructure, and wherein outside the separation region of the core tube the material of the monolithic core tube wall of the core tube has a magnetically highly conductive microstructure, in particular metal microstructure, e. g. a ferritic microstructure.

4. Magnetic actuator device according to claim 1, wherein the magnetic separation of the core tube is realized at least partly by a tapering of a wall thickness of a core tube wall of the core tube in a separation region of the core tube.

5. Magnetic actuator device according to claim 4, wherein in the separation region the core tube wall is tapered at least to a third of an average wall thickness of the core tube wall outside the separation region.

6. Magnetic actuator device according to claim 4, wherein in the separation region the wall thickness of the core tube wall is less than 0.5 mm.

7. Magnetic actuator device according to claim 4, wherein in the separation region an outer diameter of the core tube is reduced and/or that in the separation region an inner diameter of the core tube is increased.

8. Magnetic actuator device according to claim 4, wherein in the separation region the tapered wall thickness is at least substantially constant at least over a large portion of an entire axial extent of the tapering.

9. Magnetic actuator device according to claim 4, wherein a space created by the tapering-in the separation region, in particular a groove created by the tapering in the separation region, is realized free of a material filling.

10. Magnetic actuator device according to claim 4, wherein the tapering has a magnetic field conducting contour at least on the magnetic core side.

11. Magnetic actuator device according to claim 10, characterized by further comprising a magnet armature wherein, viewed in the axial direction, the magnetic field conducting contour runs completely within a radial region which proceeds from the axial direction and in which there is also a maximum reluctance gap that is producible between the magnetic core and the magnet armature in normal operation.

12. Magnetic actuator device according to claim 4, wherein the tapering has a further magnetic field conducting contour at least on the core tube side.

13. Magnetic actuator device according to claim 12, further comprising a magnet armature wherein, viewed in the axial direction, the further magnetic field conducting contour runs completely outside a radial region which proceeds from the axial direction and in which there is also a maximum reluctance gap that is producible between the magnetic core and the magnet armature in normal operation.

14. Magnetic actuator device according to claim 4, wherein the separation region, which completely comprises the tapering, has a total extent in the axial direction which is at most 25%, preferably at most 15%, of a total extent of the magnetic core in the axial direction, of a total extent of a magnet armature of the magnetic actuator device in the axial direction, and/or of a total extent of a magnetic coil of the magnetic actuator device in the axial direction.

15. Magnetic actuator device according to claim 4, further comprising a magnetic anti-adhesive element which, in the axial direction, is arranged completely outside the separation region, in particular completely outside a radial region which proceeds from the axial direction and the extent of which in the axial direction is delimited by an extent of the tapering in the axial direction.

16. Magnetic actuator device according to claim 1, wherein the core tube is on an inner side and/or on an outer side at least section-wise provided with a hydrogen diffusion inhibiting coating.

17. Magnetic actuator for hydrogen gas applications, in particular for fuel cell and/or electrolyzer applications, with a magnetic actuator device according to claim 1.

18. Method for producing a magnetic actuator device according to claim 1, with a magnetic core and with a core tube which is at least substantially magnetically separated from the magnetic core, wherein the magnetic core and the core tube are manufactured as monolithic components, and are in particular cut out of a monolithic block, and wherein the magnetic separation of the core tube is brought about by a tapering of a wall thickness of a core tube wall of the core tube, forming an unfilled separation region.

19. Method for producing a magnetic actuator device, according to claim 1, with a magnetic core and with a core tube which is at least substantially magnetically separated from the magnetic core, wherein the magnetic core and the core tube are manufactured as monolithic components, and are in particular cut out of a monolithic block, and wherein the magnetic separation of the monolithic core tube is brought about by a demagnetization of a material of the core tube wall of the core tube in a separation region of the core tube.

20. Method according to claim 19, wherein the demagnetization of the material of the core tube wall is brought about by induction heating of the separation region or by laser annealing of the separation region.
